(19) United States
(12) Patent Application Publication
(10) Pub. No.: US 2025/0124030 A1
(43) Pub. Date: Apr. 17, 2025

(54) SYSTEMS AND METHODS FOR SECURE CLOUD-BASED AND ON-PREMISES DATA MANAGEMENT

(71) Applicant: CenturyLink Intellectual Property LLC, Denver, CO (US)

(72) Inventors: Thomas C. WOLDAHL, Phoenix, AZ (US); Abid KHAN, Broomfield, CO (US); Maia FRIESER, Broomfield, CO (US); Thomas JAY, Broomfield, CO (US)

(73) Assignee: CenturyLink Intellectual Property LLC, Denver, CO (US)

(21) Appl. No.: 18/908,350

(22) Filed: Oct. 7, 2024

Related U.S. Application Data
(60) Provisional application No. 63/589,959, filed on Oct. 12, 2023.

(51) Int. Cl. G06F 16/2453

(52) U.S. Cl. CPC G06F 16/24539

(57) ABSTRACT

This disclosure describes systems, methods, and devices related to moving data between cloud-based platforms and on premise databases. A method may include providing a software platform to receive user requests for moving data from cloud platforms to on premise databases; receiving, via the software platform, a user request to move first data from a first cloud platform to a first on premise database accessible to the software platform; executing, based on the user request, using the software platform, a query for the first data; and retrieving, based on executing the query, using the software platform, the first data.

### CROSS-REFERENCE TO RELATED APPLICATIONS

This application claims the benefit of priority from U.S. Provisional Application No. 63/589,959, filed Oct. 12, 2023, which is incorporated herein in its entirety by reference.

This application is related to U.S. patent application Ser. No. 17/812,858, filed Jul. 15, 2022, titled “SYSTEM AND METHODS FOR IDENTIFYING DEFECTS IN LOCAL LOOPS,” published as U.S. Publication No. 2023/0013462, the entire contents of which are incorporated herein by reference for all purposes.

### FIELD OF THE DISCLOSURE

The present disclosure relates to cloud-based data management, and more particularly, to computerized mechanisms for controlling and managing data by and between cloud-based platforms and on-premises databases.

### SUMMARY OF THE DISCLOSURE

According to some embodiments, as discussed herein, the instant disclosure provides systems and methods for a computerized framework for secure and efficient data movement between cloud platforms and on-premises databases. As discussed herein, the disclosed framework provides a technical solution that addresses fundamental inefficiencies in conventional cloud platforms where data storage and transfer mechanisms can lead to operational inefficiencies and security concerns.

In some embodiments, the disclosed framework provides a comprehensive solution for transferring large-scale, resource-intensive datasets between cloud environments and various database types, including but not limited to Oracle and Postgres. The framework supports multiple data format outputs including JSON, CSV, and direct schema/table loads, implementing a novel combination of on-premises searches, cloud platform query tables, Java Database Connectivity (JDBC) connections, and automated scheduling capabilities.

In some embodiments, the disclosed framework can operate to incorporate an advanced integration architecture that enables seamless interaction between cloud services and on-premises resources. According to some embodiments, the framework's architecture can optimize computing costs for data queries while providing automated process flow management, including scheduled jobs and cached results for enhanced performance. The framework integrates effectively with serverless data warehouses such as BigQuery, while maintaining robust security protocols throughout the data movement process.

In some embodiments, the disclosed framework provides a sophisticated query management system that enables real-time on-premises database querying capabilities alongside cached query results for cloud-based queries. In some embodiments, the framework features a web-based interface with comprehensive REST API support, secured through an API key authentication system. Query responses can be downloaded in multiple formats, ensuring compatibility with various downstream systems and use cases.

In some embodiments, the disclosed framework can implement comprehensive administrative controls through specific interfaces for query management, data mover configuration, and job scheduling. Such interfaces provide granular control over data movement operations, including source and destination parameters, temporal controls, and time zone management. In some embodiments, the framework can include robust database settings management capabilities and a user role-based access control system, complemented by detailed logging and monitoring functionality.

Accordingly, the framework provides a technical solution that represents a significant advancement in cloud-to-database data movement capabilities, addressing specific technical challenges in existing systems while providing a scalable, secure, and efficient platform for enterprise data management needs. The disclosed framework achieves reduced computational overhead in data transfer operations, enhanced security through controlled data movement paths, improved efficiency through cached result management, and flexibility in data format handling and conversion. The automated scheduling capabilities significantly reduce manual intervention requirements while maintaining high levels of operational efficiency.

The framework's architecture ensures optimal resource utilization while maintaining data integrity and security throughout the transfer process, representing a novel approach to solving the technical challenges associated with large-scale data movement between disparate systems. This comprehensive solution meets the growing need for efficient, secure, and automated data movement capabilities in modern enterprise environments.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 shows an example data platform presenting cloud-based queries, in accordance with one embodiment.

FIG. 2 shows an example cloud-based query presentable using the platform of FIG. 1, in accordance with one embodiment.

FIG. 3 shows the platform of FIG. 1 presenting fetch results of cloud-based queries, in accordance with one embodiment.

FIG. 4 shows an example on-premises query presentable using the platform of FIG. 1, in accordance with one embodiment.

FIG. 5 shows the platform of FIG. 1 presenting execution results of a query, in accordance with one embodiment.

FIG. 6 shows an example query presentable using the platform of FIG. 1, in accordance with one embodiment.

FIG. 7 shows the platform of FIG. 1 presenting fetch results of on premise queries, in accordance with one embodiment.

FIG. 8 shows the platform of FIG. 1 presenting data movers for moving data between cloud-based diagnostics as a service and on-premises data sets, in accordance with one embodiment.

FIG. 9 shows the platform of FIG. 1 presenting data inputs for a new data mover, in accordance with one embodiment.

FIG. 10 shows the platform of FIG. 1 presenting jobs for moving data between cloud-based diagnostics as a service and on-premises data sets, in accordance with one embodiment.

FIG. 11 shows the platform of FIG. 1 presenting data inputs for a new job for moving data between cloud-based diagnostics as a service and on-premises data sets, in accordance with one embodiment.

FIG. 12 shows the platform of FIG. 1 presenting settings for moving data between cloud-based diagnostics as a service and on-premises data sets, in accordance with one embodiment.

FIG. 13 shows the platform of FIG. 1 presenting WTNs for moving data between cloud-based diagnostics as a service and on-premises data sets, in accordance with one embodiment.

FIG. 14 shows an example architecture for moving data between cloud-based diagnostics as a service and on-premises data sets, in accordance with one embodiment.

FIG. 15 shows an example cloud platform architecture for an organization using diagnostics as a service, in accordance with one embodiment.

FIG. 16 is a diagram illustrating an example of a computing system that may be used in implementing embodiments of the present disclosure.

FIG. 17 is a block diagram of an example configuration within which the systems and methods disclosed herein could be implemented according to some embodiments of the present disclosure.

FIG. 18 is a block diagram illustrating components of an exemplary system according to some embodiments of the present disclosure;

FIG. 19 illustrates an exemplary workflow according to some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. By way of background, conventional cloud platforms store data that may not be efficiently movable to certain types of databases. Such inefficiencies may be tied to the manner they are secured, handled and/or processed, which can lead to in accuracies and/or inefficiencies in the manner such data is stored and/or securely transferred among such network and/or local locations.

Aspects of the present disclosure involve systems, methods, and the like, for moving data between cloud-based platform projects and on-premises databases.

The present disclosure provides techniques for moving data (e.g., large amounts of data that are often resource-intensive to move) between cloud platforms to any database, including Oracle and Postgres, for example, as a JSON, CSV, or direct schema/table load using a combination of searches on-premises (e.g., at user's local networks/software rather than in a cloud platform), searches to cloud platform query tables, Java Database Connectivity (JBDC) connections, and a scheduler to automate the delivery of data sets anywhere and at any time. A platform (e.g., software platform or application) may provide integration with cloud services and on-premises resources while limiting computing cost to query data and managing process flow to include scheduled jobs and cached results for improved performance. The platform may integrate with serverless data warehouses like BigQuery, and may provide access to results quickly without additional cost to re-run the query. Query responses may be downloaded to JSON or CSV files. On-premises databases may be queries connected to the platform. On-premises queries may be in real-time and not based on cached query results. An intuitive web interface for the data platform may support a robust set of REST APIs to access the BigQuery (or otherwise) cached results. Using a provided application programming interface (API) key and secret may provide access to the data from anther application as an HTTP REST GET request, for example.

In one or more embodiments, the platform may present existing queries and an option to add new queries. The queries may each have a name, owner, query details, an active/inactive status, and options to execute, fetch, view, and edit. When a fetch is requested, the platform may present fetch results, including the status of the query (e.g. success or not), when the query was created, a result count, and options to view the fetch results as a JSON or CSV file, for example. When a new query is requested, the platform may prompt a user to provide a name, query details, and a JSON for the query. The platform may distinguish and present on-premises queries, including their names, owners, database connections, query details, an active/inactive status, and options to execute, fetch, view, and edit. When a user requests execution results, the platform may present the execution results of queries, including their names, status (e.g., success or not), result count, and options to present the results as a JSON or CSV file. A user may request a new on-premises query, and the platform may prompt the user to provide a name, database connection, query details, and JSON for the on-premises query.

In one or more embodiments, the platform may present data movers, including their names, source type (e.g., on premise, BigQuery, etc.), source query name, destination type (e.g., on premise, BigQuery, etc.), destination reference, an active/inactive status, and options to execute, fetch, view, and edit. The platform also may provide an option to add a new data mover. When a user requests a new data mover, the platform may prompt the user for the data mover name, the query source (e.g., BigQuery or on-premises query source), the query destination for data movement, and a JSON.

In one or more embodiments, the platform may present jobs, including job names, owners, source, schedule, last run date/time, and options to fetch, view, and edit. The platform also may provide an option for adding a new job. When a user requests a new job, the platform may prompt the user to provide a job name, a source for a scheduled job (e.g., BigQuery, on premise query, or data mover), the years, months, days, hours, minutes, and/or time zone for the scheduled job, and a JSON.

In one or more embodiments, the platform may present settings, including name, type (e.g., database settings), server, and options to view and edit the settings. The platform also may provide an option for adding new settings. When a user requests a new database setting, the platform may prompt the user to input a name for the setting, a type of setting, a server to which the setting is applied, a port to which the setting is applied, a database to which the setting is applied, a database type, a user, and a password.

In one or more embodiments, the platform may present users, including usernames, roles (e.g., administrators, developers, users, super users, etc.), last logins by any user, an active/inactive/disabled indicator, an options to reset password, view, or edit a user profile. The platform also may provide an option to add a new user. When a user requests to add a new user, the platform may prompt the user to provide an email address, password, and user role.

In one or more embodiments, the platform may present WTNs, including the WTN number, status, and reason (e.g., why not, none, etc.). The platform may present an option to add a new WTN. When a user requests a new WTN, the platform may prompt the user to provide the WTN number, the status, and the reason.

In one or more embodiments, the platform may present logs, including the user of a log, an event type (e.g., successful login event, etc.), details of the event (e.g., successful login from a particular address), and a timestamp of the event.

The above descriptions are for purposes of illustration and are not meant to be limiting. Numerous other examples, configurations, processes, etc., may exist, some of which are described in greater detail below. Example embodiments will now be described with reference to the accompanying figures.

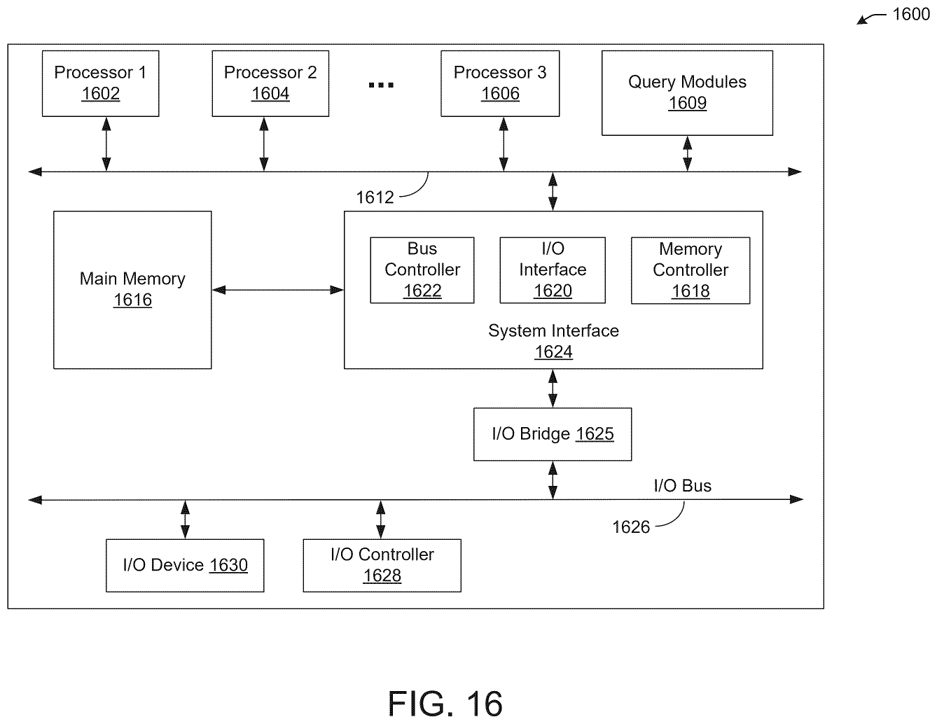

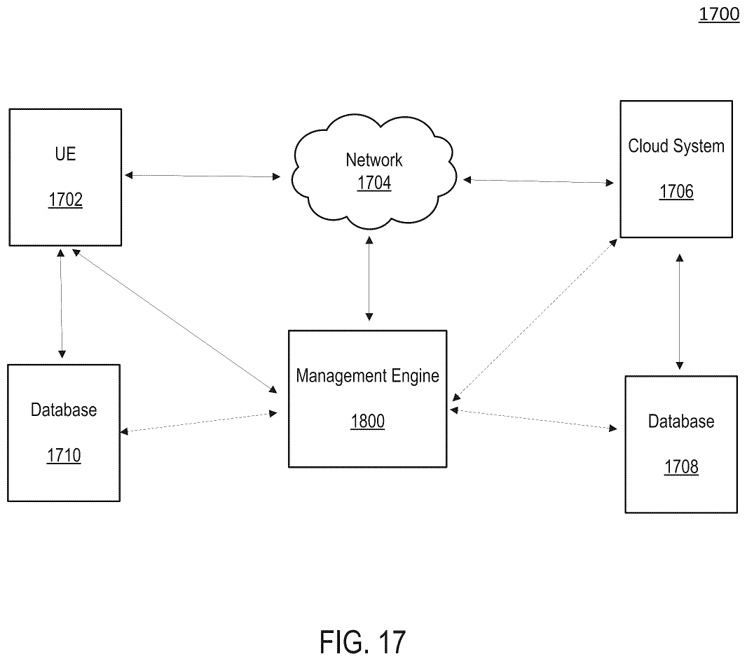

Turning to FIG. 17, depicted is system 1700 is depicted which includes user equipment (UE) 1702 (e.g., a client device, as mentioned above, and/or computer device or computer system 1600 in FIG. 16, discuss supra), database 1710, network 1704, cloud system 1706, database 1708 and management engine 1800. It should be understood that while system 100 is depicted as including such components, it should not be construed as limiting, as one of ordinary skill in the art would readily understand that varying numbers of UEs, peripheral devices, cloud systems, databases and networks can be utilized; however, for purposes of explanation, system 1700 is discussed in relation to the example depiction in FIG. 17.

According to some embodiments, UE 1702 can be any type of device, such as, but not limited to, a mobile phone, tablet, laptop, sensor, Internet of Things (IoT) device, autonomous machine, and any other device equipped with a cellular or wireless or wired transceiver. For example, UE 1702 can be a smart phone with applications installed and/or accessible thereon. In another non-limiting example, UE 1702 can correspond to a laptop of an employee of an organization that has an Internet Service Provider (ISP) and/or communication service provider (CSP) account with an ISP/CSP provider.

In some embodiments, a peripheral device (not shown) can be connected to UE 1702, and can be any type of peripheral device, such as, but not limited to, a wearable device (e.g., smart ring or smart watch), printer, speaker, sensor, and the like. In some embodiments, a peripheral device can be any type of device that is connectable to UE 1702 via any type of known or to be known pairing mechanism, including, but not limited to, WiFi, Bluetooth™, Bluetooth Low Energy (BLE), NFC, and the like. For example, the peripheral device can be a smart phone, smart ring, smart watch or other wearable device that connectively pairs with UE 1702, which is a user's laptop.

In some embodiments, network 1704 can be any type of network, such as, but not limited to, a wireless network, cellular network, the Internet, and the like (as discussed above). Network 1704 facilitates connectivity of the components of system 1700, as illustrated in FIG. 17.

According to some embodiments, cloud system 1706 may be any type of cloud operating platform and/or network based system upon which applications, operations, and/or other forms of network resources may be located. For example, system 1706 may be a service provider and/or network provider from where services and/or applications may be accessed, sourced or executed from. For example, system 1706 can represent the cloud-based architecture associated with a smart home or network provider, which has associated network resources hosted on the internet or private network (e.g., network 1704), which enables (via engine 1800) the sleep management discussed herein.

In some embodiments, cloud system 1706 may include a server(s) and/or a database of information which is accessible over network 1704. In some embodiments, a database 1708 of cloud system 1706 may store a dataset of data and metadata associated with local and/or network information related to a user(s) of the components of system 1700 and/or each of the components of system 1700 (e.g., UE 1702, and the services and applications provided by cloud system 1706 and/or management engine 17800).

In some embodiments, for example, cloud system 1706 can provide a private/proprietary management platform, whereby engine 1800, discussed infra, corresponds to the novel functionality system 1706 enables, hosts and provides to a network 1704 and other devices/platforms operating thereon.

In some embodiments, the exemplary computer-based systems/platforms, the exemplary computer-based devices, and/or the exemplary computer-based components of the present disclosure may be specifically configured to operate in a cloud computing/architecture 1706 such as, but not limiting to: infrastructure as a service (IaaS), platform as a service (PaaS), and/or software as a service (SaaS) using a web browser, mobile app, thin client, terminal emulator or other endpoint 604. In some embodiments, the architecture can also be network as a service (Naas).

According to some embodiments, databases 1710 and 1708 may correspond to a data storage for a platform (e.g., a network hosted platform, such as cloud system 1706, as discussed supra) or a plurality of platforms. Database 1710 and 1708 may receive storage instructions/requests from, for example, engine 1800 (and associated microservices), which may be in any type of known or to be known format, such as, for example, standard query language (SQL). According to some embodiments, database 1710 and 1708 may correspond to any type of known or to be known storage, for example, a memory or memory stack of a device, a distributed ledger of a distributed network (e.g., blockchain, for example), a look-up table (LUT), and/or any other type of secure data repository

Management engine 1800, as discussed above and further below in more detail, can include components for the disclosed functionality. According to some embodiments, management engine 1800 may be a special purpose machine or processor, and can be hosted by a device on network 1704, within cloud system 1706, and/or on UE 1702. In some embodiments, engine 1800 may be hosted by a server and/or set of servers associated with cloud system 1706.

According to some embodiments, as discussed in more detail below, management engine 1800 may be configured to implement and/or control a plurality of services and/or microservices, where each of the plurality of services/microservices are configured to execute a plurality of workflows associated with performing the disclosed security management. Non-limiting embodiments of such workflows are provided below.

According to some embodiments, as discussed above, management engine 1800 may function as an application provided by cloud system 106. In some embodiments, engine 1800 may function as an application installed on a server(s), network location and/or other type of network resource associated with system 1706. In some embodiments, engine 1800 may function as an application installed and/or executing on UE 1702. In some embodiments, such application may be a web-based application accessed by UE 1702 and/or other devices over network 1704 from cloud system 106. In some embodiments, engine 1800 may be configured and/or installed as an augmenting script, program or application (e.g., a plug-in or extension) to another application or program provided by cloud system 1706 and/or executing on UE 1702.

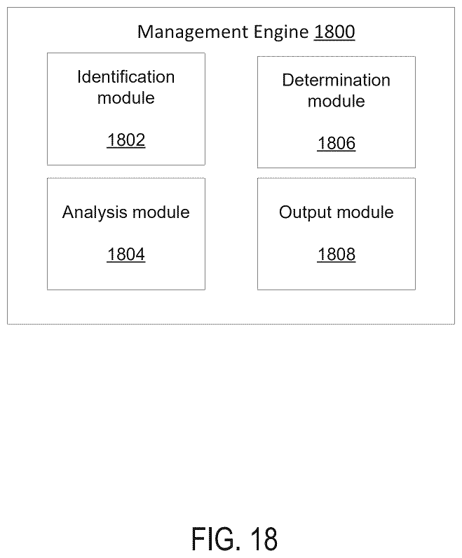

As illustrated in FIG. 18, according to some embodiments, management engine 1800 includes identification module 1802, analysis module 1804, determination module 1806 and output module 1808. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 1800 and each of its modules, and their role within embodiments of the present disclosure will be discussed below.

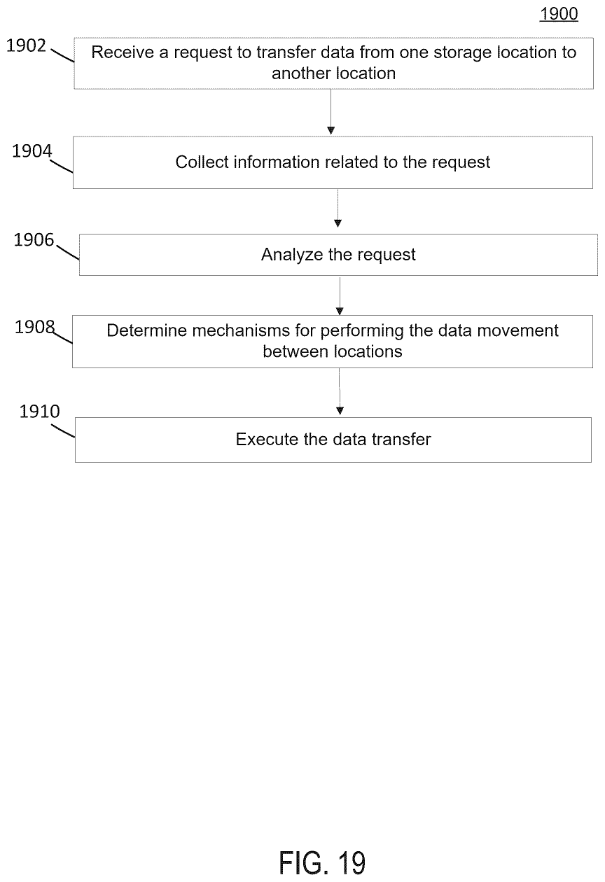

Turning to FIG. 19, Process 1900 provides non-limiting example embodiments for the disclosed data management framework by/between cloud and/or on-premises devices.

According to some embodiments, as discussed herein, the present disclosure provides techniques for transferring large amounts of data between cloud platforms and databases, such as Oracle and Postgres. This transfer may be done as JSON, CSV, or direct schema/table loads using a combination of on-premises searches, cloud platform query table searches, Java Database Connectivity (JBDC) connections, and an automated scheduler. A platform may integrate cloud services with on-premises resources, managing process flow with scheduled jobs and cached results for better performance. It supports serverless data warehouses like BigQuery and offers rapid access to query results without re-running queries, allowing downloads in JSON or CSV formats. Real-time on-premises queries are supported, with an intuitive web interface providing REST APIs for access via an API key or HTTP REST GET requests.

In one or more embodiments, the platform presents existing and new queries, showing details like name, owner, and status. Fetch requests display results such as status and result count, with options to download as JSON or CSV. The platform also handles on-premises queries, data movers (tracking source and destination), and scheduled jobs, prompting users for relevant details. In some embodiments, the framework provides capabilities for users to configure settings, manage profiles, and view logs of events like login attempts.

According to some embodiments, Steps 1902 and 1904 of Process 1900 can be performed by identification module 1802 of management engine 1800; Step 1906 can be performed by analysis module 1804; Step 1908 can be performed by determination module 1806; and Step 1910 can be performed by output module 1808.

According to some embodiments, Process 1900 begins with Step 1902 where a request to transfer data from a stored location to another location is received. As discussed above, the initial storage location can be a cloud platform and/or corresponding database associated with a cloud (e.g., database 1708 and cloud system 1706 in FIG. 17, discussed supra). Accordingly, operations can operate to handle requests for transferring large amounts of data from cloud platforms (e.g., BigQuery) to on-premises locations, such as databases like Oracle or Postgres. Such requests, in some embodiments, can involve data transfer in various formats like JSON, CSV, or direct schema/table loads.

In Step 1904, information related to the request can be collected, which can be related to, but not limited to, the requesting entity, the transferring entity, the receiving entity, the data being transferred, the request, and the like. In some embodiments, for example, upon receiving the request, engine 1800 can gather key details such as, but not limited to, the name of the query, the owner, the source and destination types (e.g., cloud or on-premises), and the required data format. In some embodiments, engine 1800 can also prompts the user to specify additional parameters like database connection details, scheduling, and whether real-time data or cached results are required.

In Step 1906, engine 1800 can analyze the request to determine, but not limited to, the mechanics for the transfer, and/or the location for where the transfer of data is to result. In some embodiments, engine 1800 analyzes the provided information, ensuring that all necessary data points, such as source and destination settings, are configured correctly. In some embodiments, engine 1800 can check the status of the query (active/inactive) and whether any specific formatting or transformations (e.g., JSON or CSV output) are needed. In some embodiments, if/when on-premises resources are involved, engine 1800 verifies the real-time nature of the query.

In some embodiments, such analysis can involve engine 1800 implementing any type of known or to be known computational analysis technique, algorithm, mechanism or technology to analyze the collected information from Step 1904.

In some embodiments, engine 1800 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 1800 may leverage a large language model (LLM), whether known or to be known. An LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 1800 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 1800 can implement an XGBoost algorithm for regression and/or classification to analyze the user data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 1908, based on the analysis from Step 1906, engine 1800 can determine the mechanisms for the transfer of the data from the cloud to on-prem. In some embodiments, engine 1800 can selects the appropriate mechanisms for executing the transfer, which can involve a combination of Java Database Connectivity (JDBC) connections, on-premises queries, and cloud-based query table searches. In some embodiments, depending on the specifics of the request and/or type and/or volume of data, engine 1800 may decide between using a scheduler for automated data movement, serverless data warehouses like BigQuery, or REST APIs for programmatic data access.

And, in Step 1910, engine 1800 can executed the transfer based on the determined mechanism(s) from Step 1908. In some embodiments, engine 1800 can cause the transfer by moving data between the cloud platform and the on-premises location. In some embodiments, functionality can be provided to enable a user(s) (e.g., requesting entity and/or receiving entity, for example) to monitor the process through logs, and upon completion, the data can be downloaded in the requested format. In some embodiments, if/when scheduled jobs are involved, engine 1800 can manage the timing and execution based on the provided schedule, ensuring a seamless and cost-effective data movement process.

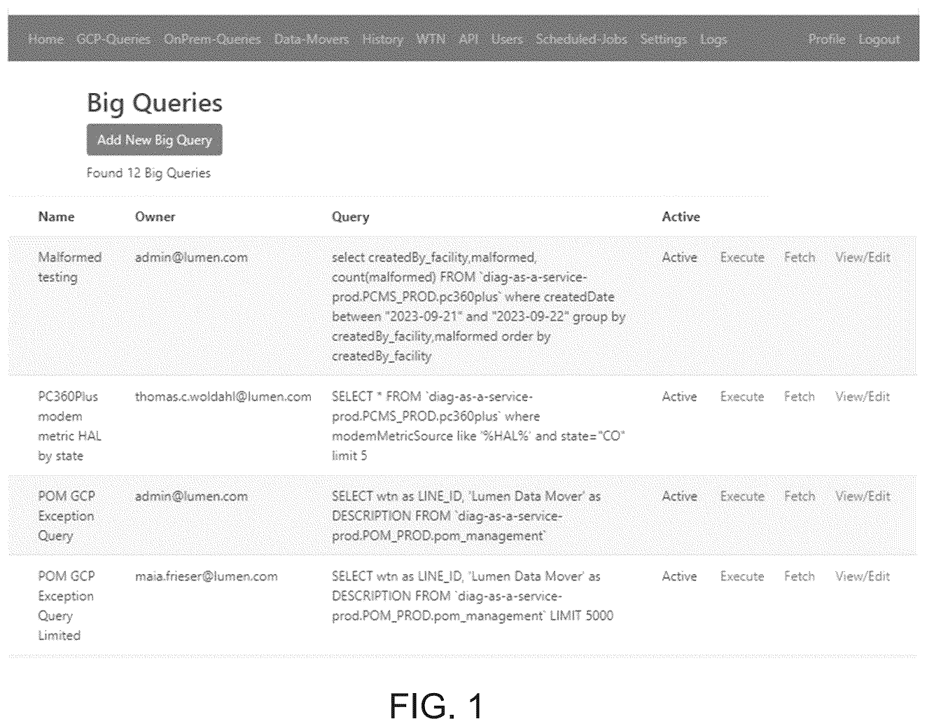

Turning to FIG. 1, depicted is an example data platform presenting cloud-based queries, in accordance with one embodiment.

In one or more embodiments, the platform may present existing queries and an option to add new queries. The queries may each have a name, owner, query details, an active/inactive status, and options to execute, fetch, view, and edit. When a fetch is requested, the platform may present fetch results, including the status of the query (e.g. success or not), when the query was created, a result count, and options to view the fetch results as a JSON or CSV file, for example. When a new query is requested, the platform may prompt a user to provide a name, query details, and a JSON for the query.

Selecting the execute option may cause execution of the query, including caching the results. The platform may present the query results using a JSON file or CSV file, for example. If a query has been executed at least once, the fetch option may return the cached values of the query results of the latest execution of that query, avoiding the need to execute the query again. In this manner, the platform may use logic to determine which commands are needed to return data from a query. Each execution of a query may override the values in the cache for that query with the latest results.

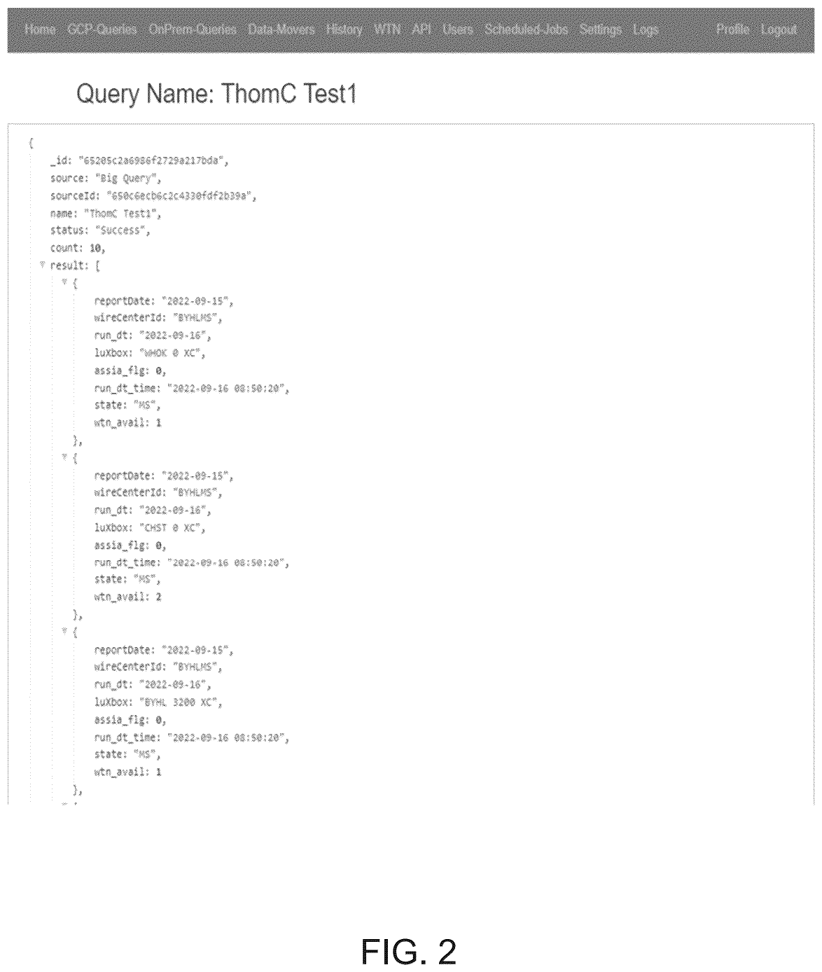

FIG. 2 shows an example cloud-based query presentable using the platform of FIG. 1, in accordance with one embodiment.

In particular, the JSON file of a fetched query is shown.

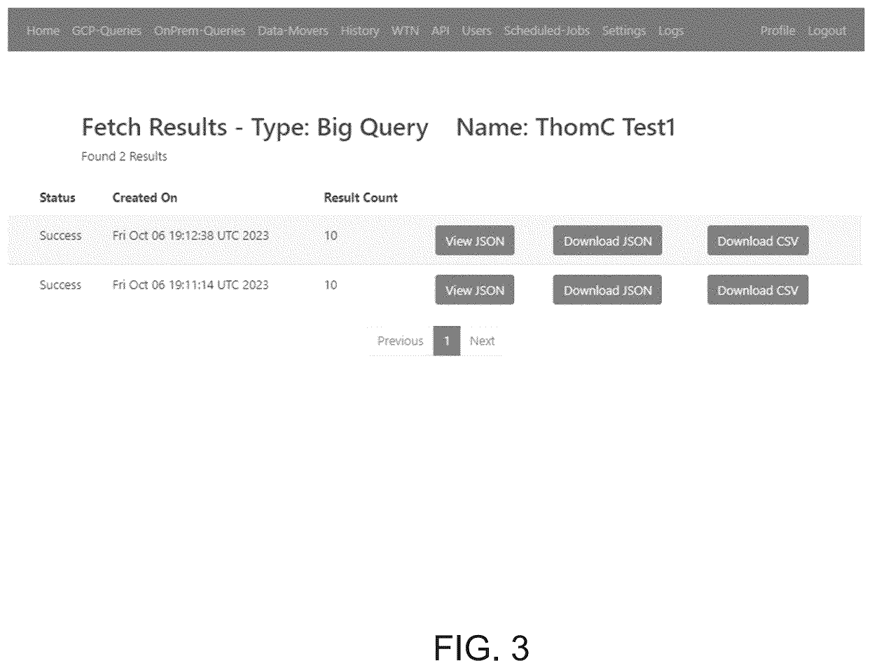

FIG. 3 shows the platform of FIG. 1 presenting fetch results of cloud-based queries, in accordance with one embodiment.

The results shown in FIG. 3 may be results from fetching a query shown by the platform.

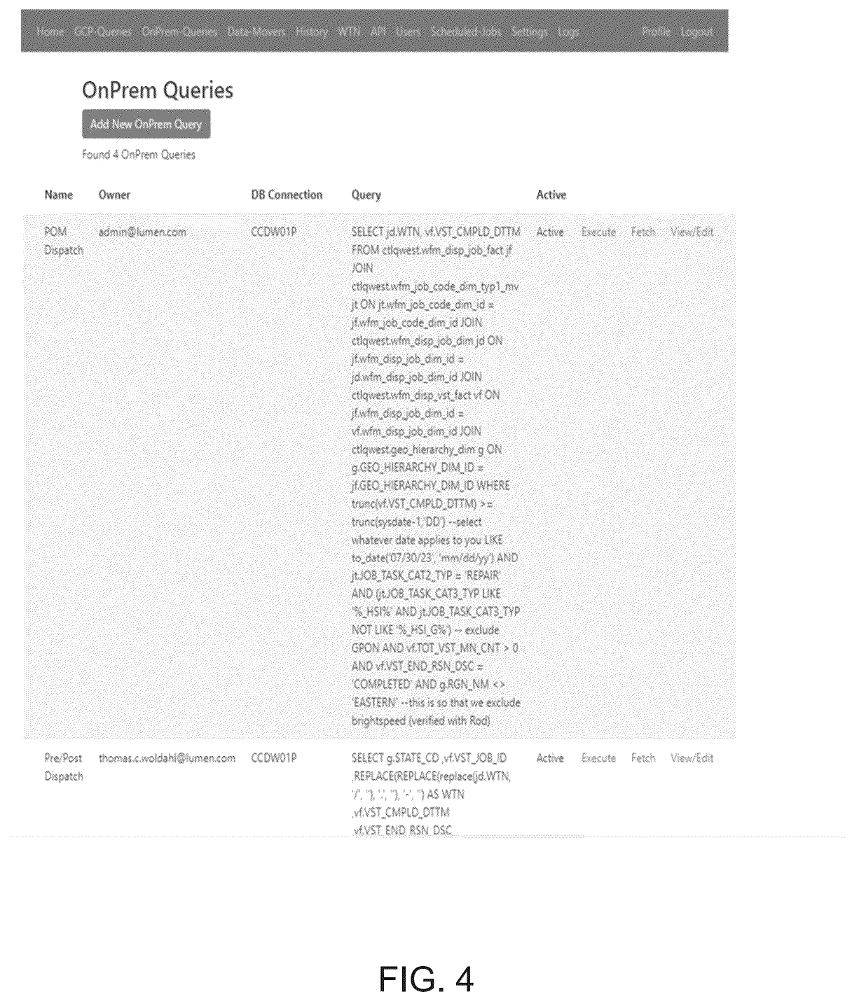

FIG. 4 shows an example on-premises query presentable using the platform of FIG. 1, in accordance with one embodiment.

The platform may distinguish and present on-premises queries, including their names, owners, database connections, query details, an active/inactive status, and options to execute, fetch, view, and edit. When a user requests execution results, the platform may present the execution results of queries, including their names, status (e.g., success or not), result count, and options to present the results as a JSON or CSV file. A user may request a new on-premises query, and the platform may prompt the user to provide a name, database connection, query details, and JSON for the on-premises query.

Selecting the execute option may cause execution of the on premise query, including caching the results. The platform may present the query results using a JSON file or CSV file, for example. If a query has been executed at least once, the fetch option may return the cached values of the query results of the latest execution of that query, avoiding the need to execute the query again. In this manner, the platform may use logic to determine which commands are needed to return data from a query. Each execution of a query may override the values in the cache for that query with the latest results.

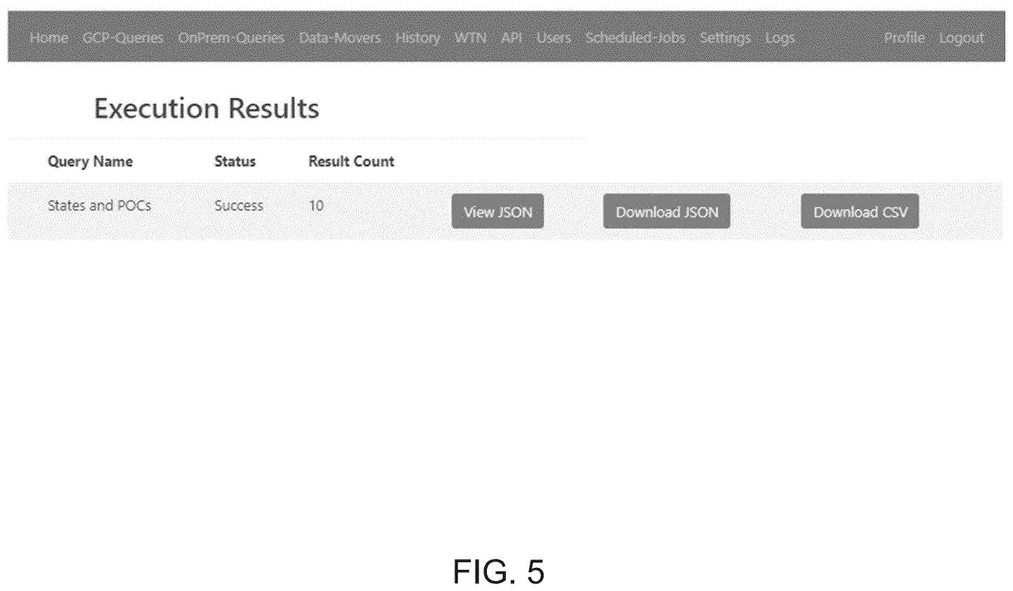

FIG. 5 shows the platform of FIG. 1 presenting execution results of a query, in accordance with one embodiment.

When a user requests execution results, the platform may present the execution results of queries, including their names, status (e.g., success or not), result count, and options to present the results as a JSON or CSV file.

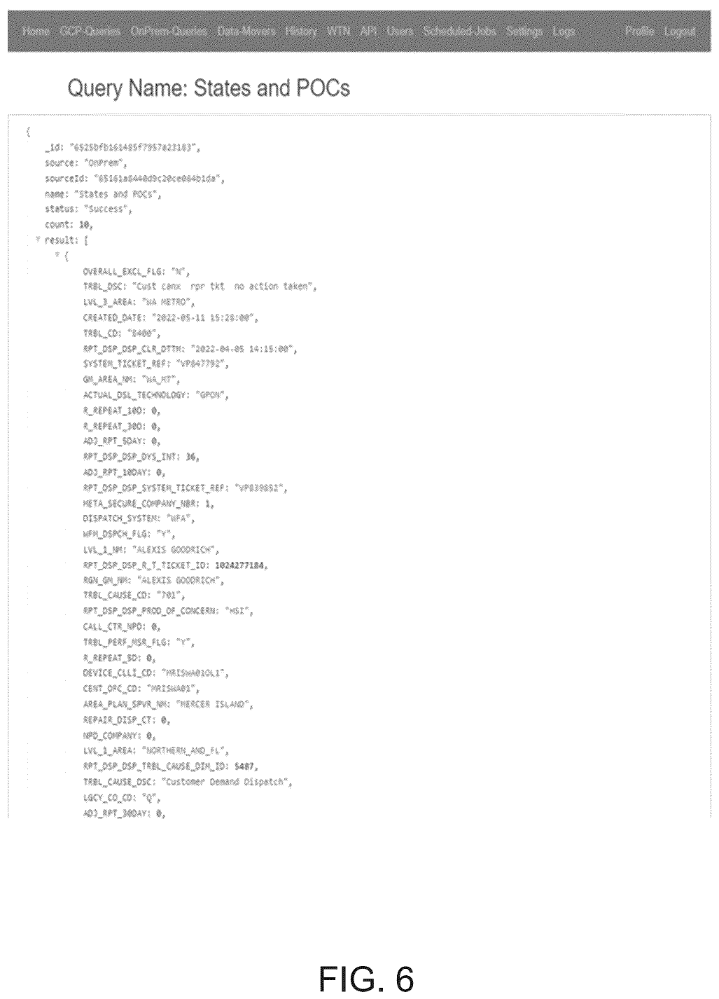

FIG. 6 shows an example query presentable using the platform of FIG. 1, in accordance with one embodiment.

In particular, the JSON file of a fetched on premise query is shown.

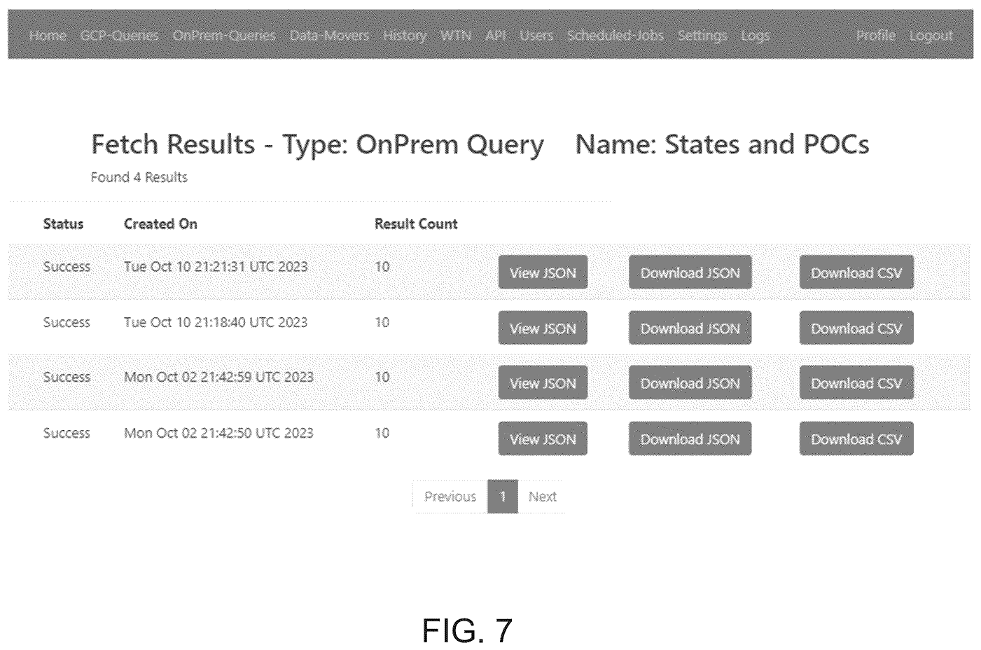

FIG. 7 shows the platform of FIG. 1 presenting fetch results of on premise queries, in accordance with one embodiment.

When a user requests the fetch option for a query, the platform may present the query results using a JSON file or CSV file, for example. If a query has been executed at least once, the fetch option may return the cached values of the query results of the latest execution of that query, avoiding the need to execute the query again. In this manner, the platform may use logic to determine which commands are needed to return data from a query. Each execution of a query may override the values in the cache for that query with the latest results.

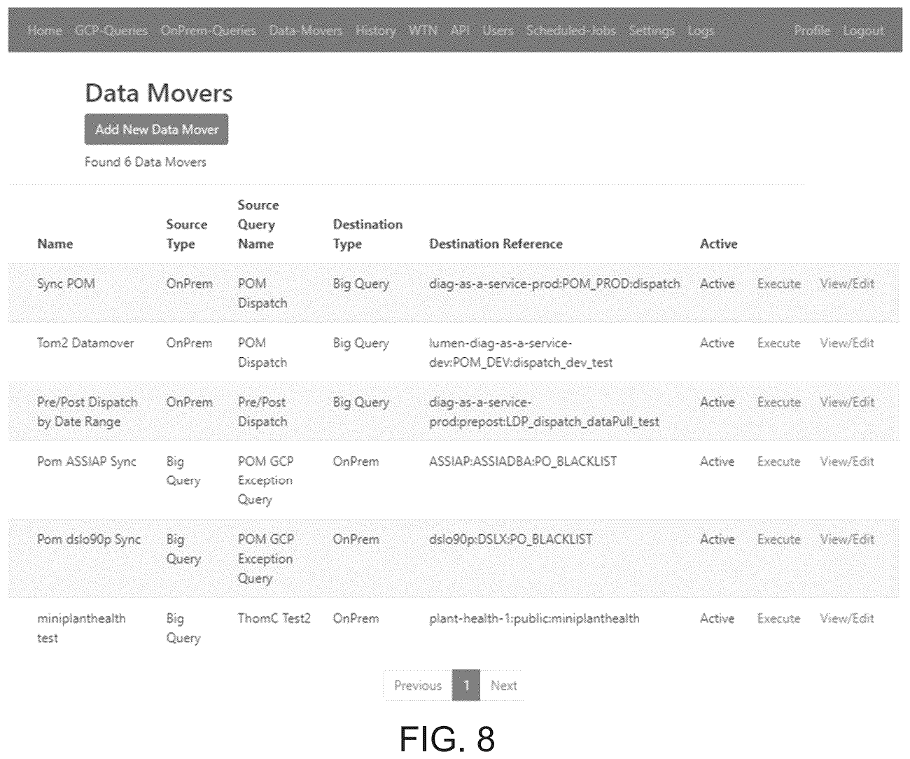

FIG. 8 shows the platform of FIG. 1 presenting data movers for moving data between cloud-based diagnostics as a service and on-premises data sets, in accordance with one embodiment.

The platform may present data movers, including their names, source type (e.g., on premise, BigQuery, etc.), source query name, destination type (e.g., on premise, BigQuery, etc.), destination reference, an active/inactive status, and options to execute, fetch, view, and edit. The platform also may provide an option to add a new data mover.

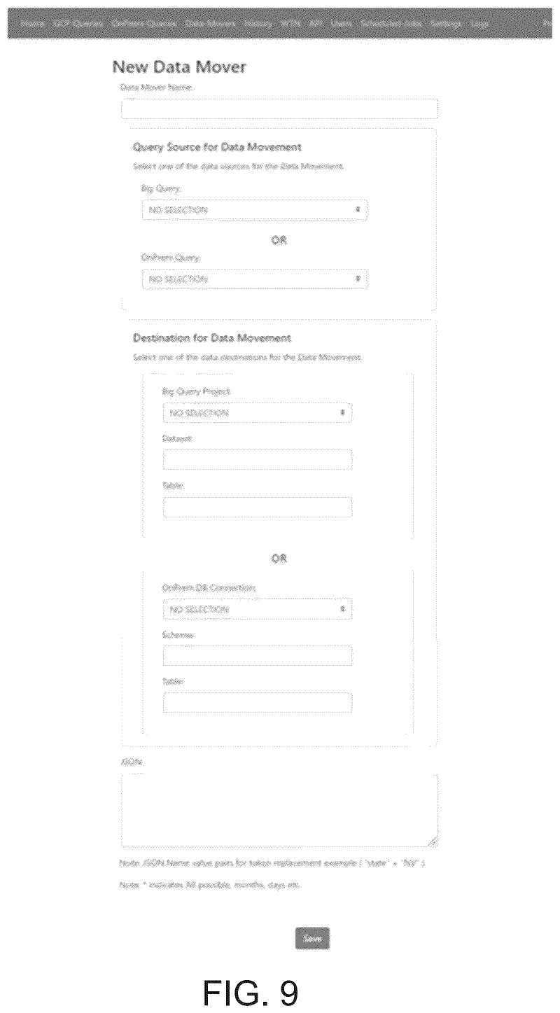

FIG. 9 shows the platform of FIG. 1 presenting data inputs for a new data mover, in accordance with one embodiment.

When a user requests a new data mover, the platform may prompt the user for the data mover name, the query source (e.g., BigQuery or on-premises query source), the query destination for data movement, and a JSON.

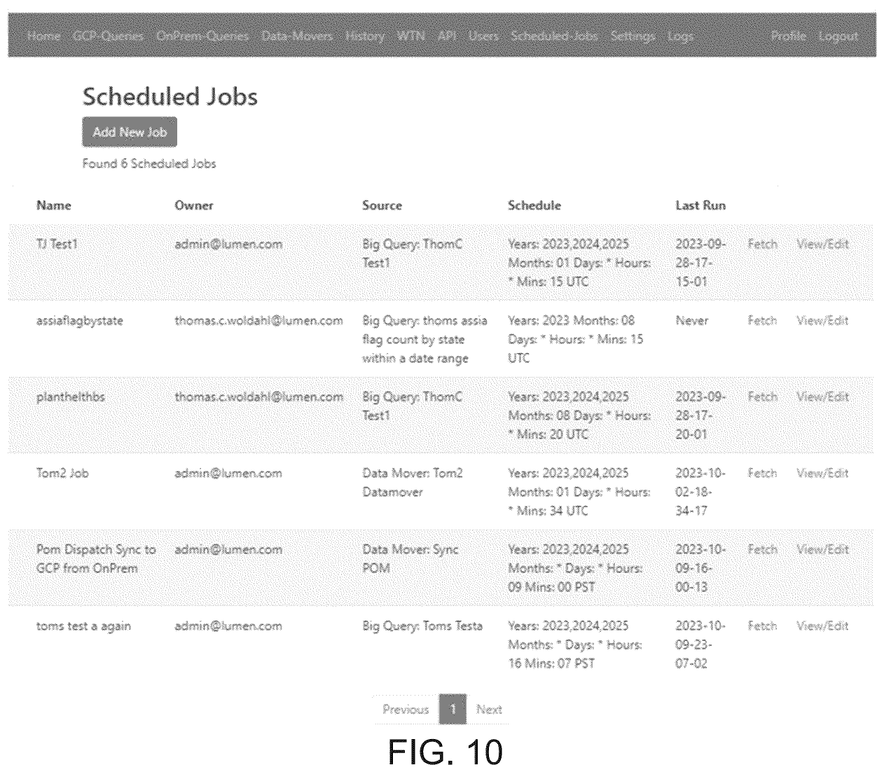

FIG. 10 shows the platform of FIG. 1 presenting jobs for moving data between cloud-based diagnostics as a service and on-premises data sets, in accordance with one embodiment.

In one or more embodiments, the platform may present jobs, including job names, owners, source, schedule, last run date/time, and options to fetch, view, and edit. The platform also may provide an option for adding a new job.

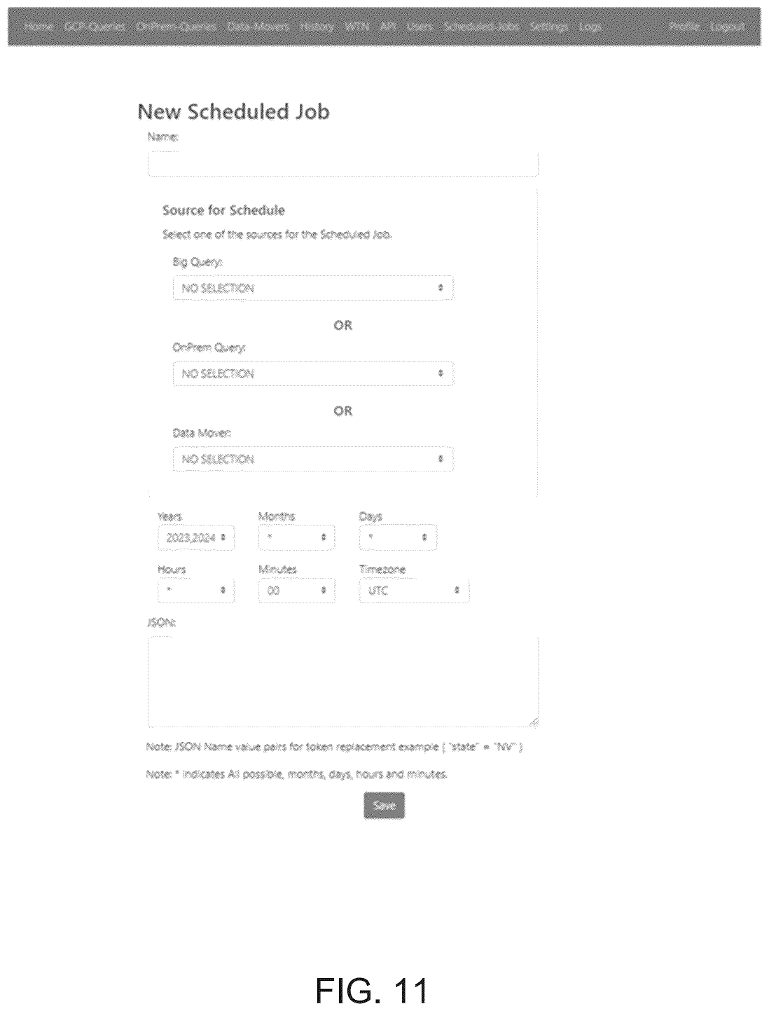

FIG. 11 shows the platform of FIG. 1 presenting data inputs for a new job for moving data between cloud-based diagnostics as a service and on-premises data sets, in accordance with one embodiment.

When a user requests a new job, the platform may prompt the user to provide a job name, a source for a scheduled job (e.g., BigQuery, on premise query, or data mover), the years, months, days, hours, minutes, and/or time zone for the scheduled job, and a JSON.

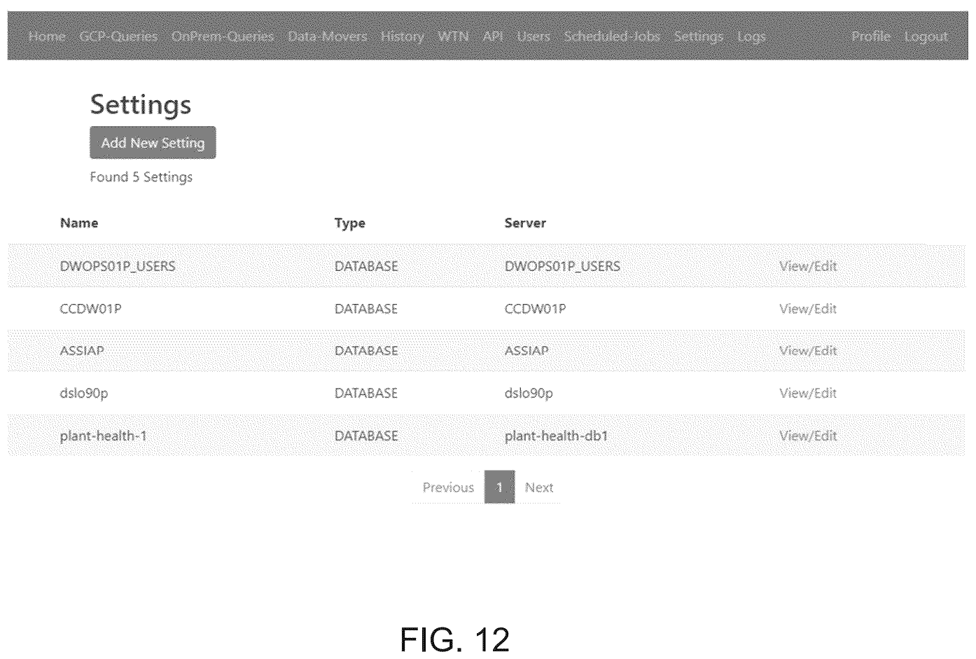

FIG. 12 shows the platform of FIG. 1 presenting settings for moving data between cloud-based diagnostics as a service and on-premises data sets, in accordance with one embodiment.

In one or more embodiments, the platform may present settings, including name, type (e.g., database settings), server, and options to view and edit the settings. The platform also may provide an option for adding new settings. When a user requests a new database setting, the platform may prompt the user to input a name for the setting, a type of setting, a server to which the setting is applied, a port to which the setting is applied, a database to which the setting is applied, a database type, a user, and a password.

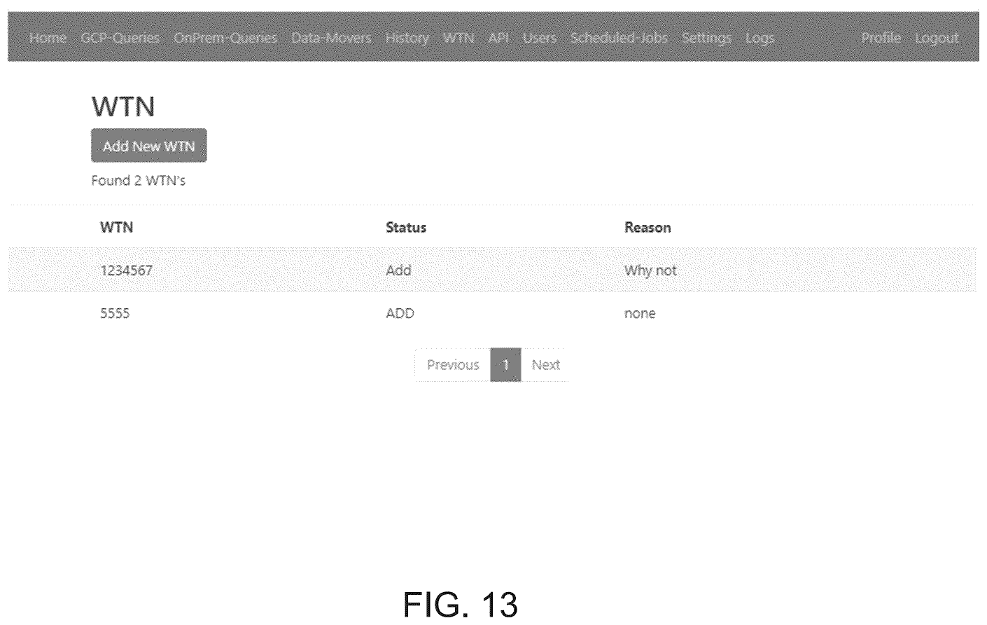

FIG. 13 shows the platform of FIG. 1 presenting WTNs for moving data between cloud-based diagnostics as a service and on-premises data sets, in accordance with one embodiment.

In one or more embodiments, the platform may present WTNs, including the WTN number, status, and reason (e.g., why not, none, etc.). The platform may present an option to add a new WTN. When a user requests a new WTN, the platform may prompt the user to provide the WTN number, the status, and the reason.

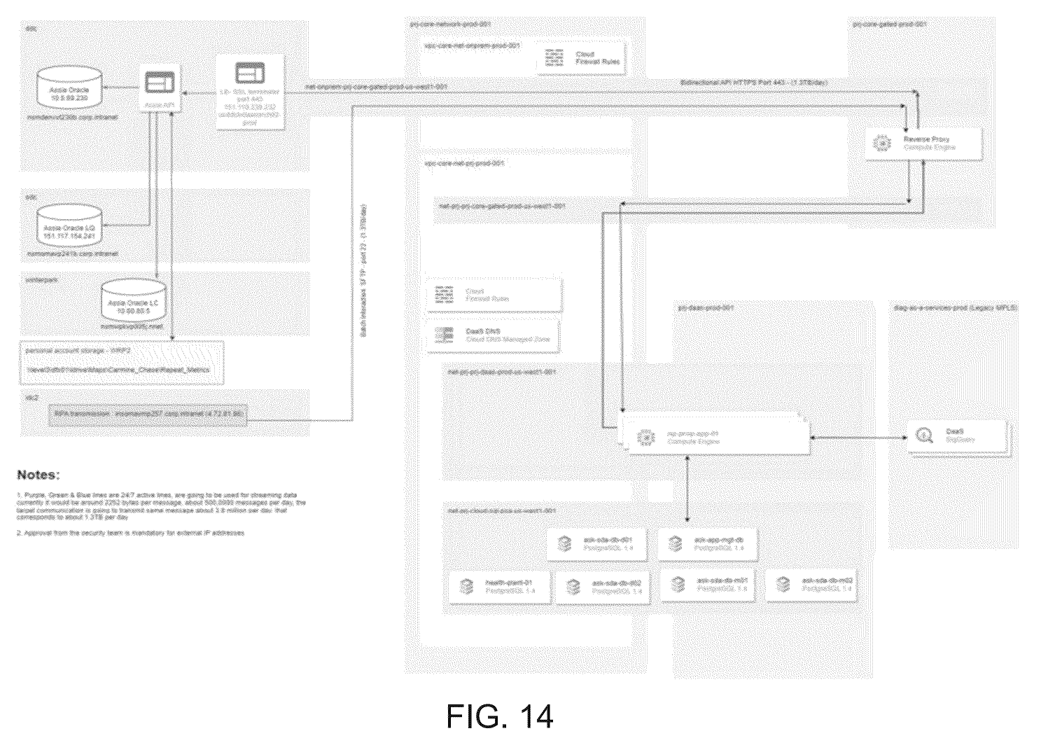

FIG. 14 shows an example architecture for moving data between cloud-based diagnostics as a service and on-premises data sets, in accordance with one embodiment.

Referring to FIG. 14, on premises queries may connect to a cloud-based query (e.g., BigQuery) and vice versa using multiple on premise servers and a cloud platform project.

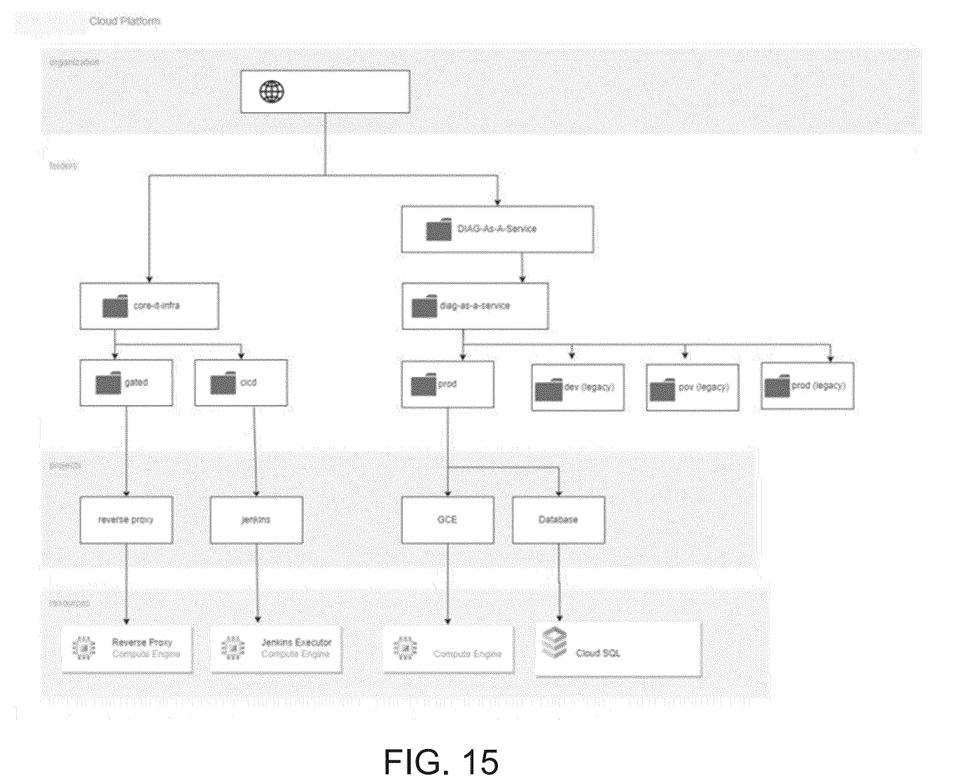

FIG. 15 shows an example cloud platform architecture for an organization using diagnostics as a service, in accordance with one embodiment.

Referring to FIG. 15, an organization may use a cloud platform and may have multiple folders in the cloud platform (e.g., including diagnostics as a service folders). The folders may access projects in the cloud platform (e.g., cloud platform projects), which may access various compute and data resources in the cloud platform. The software platform of FIG. 1 may determine how to execute a query between on premises and the cloud platform or fetch results of a query.

It is understood that the above descriptions are for purposes of illustration and are not meant to be limiting.

FIG. 16 is a block diagram illustrating an example of a computing device or computer system 1600 which may be used in implementing the embodiments of the components of the network disclosed above. For example, the computing system 1600 of FIG. 16 may represent at least a portion of the architecture shown in FIGS. 14 and 15, and facilitating the platform of FIG. 1, as discussed above. The computer system (system) includes one or more processors 1602-1606, and query modules 1609 (e.g., hardware and/or software) capable of facilitating the functions of the platform of FIG. 1 as described herein. Processors 1602-1606 may include one or more internal levels of cache (not shown) and a bus controller 1622 or bus interface unit to direct interaction with the processor bus 1612. Processor bus 1612, also known as the host bus or the front side bus, may be used to couple the processors 1602-1606 with the system interface 1624. System interface 1624 may be connected to the processor bus 1612 to interface other components of the system 1600 with the processor bus 1612. For example, system interface 1624 may include a memory controller 1618 for interfacing a main memory 1616 with the processor bus 1612. The main memory 1616 typically includes one or more memory cards and a control circuit (not shown). System interface 1624 may also include an input/output (I/O) interface 1620 to interface one or more I/O bridges 1625 or I/O devices with the processor bus 1612. One or more I/O controllers and/or I/O devices may be connected with the I/O bus 1626, such as I/O controller 1628 and I/O device 1630, as illustrated.

I/O device 1630 may also include an input device (not shown), such as an alphanumeric input device, including alphanumeric and other keys for communicating information and/or command selections to the processors 1602-1606. Another type of user input device includes cursor control, such as a mouse, a trackball, or cursor direction keys for communicating direction information and command selections to the processors 1602-1606 and for controlling cursor movement on the display device.

System 1600 may include a dynamic storage device, referred to as main memory 1616, or a random access memory (RAM) or other computer-readable devices coupled to the processor bus 1612 for storing information and instructions to be executed by the processors 1602-1606. Main memory 1616 also may be used for storing temporary variables or other intermediate information during execution of instructions by the processors 1602-1606. System 1600 may include a read only memory (ROM) and/or other static storage device coupled to the processor bus 1612 for storing static information and instructions for the processors 1602-1606. The system outlined in FIG. 16 is but one possible example of a computer system that may employ or be configured in accordance with aspects of the present disclosure.

According to one embodiment, the above techniques may be performed by computer system 1600 in response to processor 1604 executing one or more sequences of one or more instructions contained in main memory 1616. These instructions may be read into main memory 1616 from another machine-readable medium, such as a storage device. Execution of the sequences of instructions contained in main memory 1616 may cause processors 1602-1606 to perform the process steps described herein. In alternative embodiments, circuitry may be used in place of or in combination with the software instructions. Thus, embodiments of the present disclosure may include both hardware and software components.

As discussed herein, a non-transitory, computer-readable and/or machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1606 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 1616, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations together with all equivalents thereof.

What is claimed is:

1. A method comprising:
receiving, by an application, a request related to data, the request comprising instructions to move the data from a first location to a second location;
analyzing, by the application, the request, and determining information for a transfer to the second location;
determining, by the application, and based on the determined information and the analysis of the request, a mechanism for performing the transfer; and
executing, by the application, the determined mechanisms, such that the data is moved from the first location to the second location.

2. The method of claim 1, further comprising querying the first location, such that the transfer is responsive to retrieval of the data from the first location.

3. The method of claim 1, further comprising identifying a cached result of a previously executed query on the data at the first location, and utilizing the cached result as a basis for the transfer of the data to the second location.

4. The method of claim 1, further comprising determining parameters for the transfer, the parameters selected from a group consisting of: database connections, scheduling, source type, destination type, query name, data owner and results type.

5. The method of claim 4, further comprising determining the mechanisms based on the determined parameters for the transfer.

6. The method of claim 1, further comprising the request corresponding to a BigQuery.

7. The method of claim 1, further comprising the first location being associated with a cloud.

8. The method of claim 1, further comprising the second location being associated with an on-premises location.

9. A system comprising:
a processor configured to:
receive, by an application, a request related to data, the request comprising instructions to move the data from a first location to a second location;
analyze, by the application, the request, and determine information for a transfer to the second location;
determine, by the application, and based on the determined information and the analysis of the request, a mechanism for performing the transfer; and
execute, by the application, the determined mechanisms, such that the data is moved from the first location to the second location.

10. The system of claim 9, wherein the processor is further configured to query the first location, such that the transfer is responsive to retrieval of the data from the first location.

11. The system of claim 9, wherein the processor is further configured to identify a cached result of a previously executed query on the data at the first location, and utilizing the cached result as a basis for the transfer of the data to the second location.

12. The system of claim 9, wherein the processor is further configured to determine parameters for the transfer, the parameters selected from a group consisting of: database connections, scheduling, source type, destination type, query name, data owner and results type.

13. The system of claim 12, wherein the processor is further configured to determine the mechanisms based on the determined parameters for the transfer.

14. The system of claim 9, wherein the processor is further configured, such that the first location is associated with a cloud.

15. The system of claim 9, wherein the processor is further configured such that the second location is associated with an on-premises location.

16. A non-transitory computer-readable storage medium tangibly encoded with computer-executable instructions, that when executed by a processor, perform a method comprising:
receiving, by an application, a request related to data, the request comprising instructions to move the data from a first location to a second location;
analyzing, by the application, the request, and determining information for a transfer to the second location;
determining, by the application, and based on the determined information and the analysis of the request, a mechanism for performing the transfer; and
executing, by the application, the determined mechanisms, such that the data is moved from the first location to the second location.

17. The non-transitory computer-readable storage medium of claim 16, further comprising querying the first location, such that the transfer is responsive to retrieval of the data from the first location.

18. The non-transitory computer-readable storage medium of claim 16, further comprising identifying a cached result of a previously executed query on the data at the first location, and utilizing the cached result as a basis for the transfer of the data to the second location.

19. The non-transitory computer-readable storage medium of claim 16, further comprising determining the mechanisms based on determined parameters for the transfer, the parameters selected from a group consisting of: database connections, scheduling, source type, destination type, query name, data owner and results type.

20. The non-transitory computer-readable storage medium of claim 16, further comprising the first location being associated with a cloud, and the second location being associated with an on-premises location.
